(19) United States
(12) Patent Application Publication
(10) Pub. No.: US 2008/0125330 A1
(43) Pub. Date: May 29, 2008

(54) Real-Time Pcr Detection of Microorganisms Using an Integrated Microfluidics Platform

(75) Inventors: Nathaniel C. Cady, Ithaca, NY (US); Carl A. Batt, Groton, NY (US); Scott J. Stelick, Ithaca, NY (US); Madanagopal V. Kunnavakkam, Santa Clara, CA (US); Xin Yang, Auburndale, MA (US)

Correspondence Address: JONES, TULLAR & COOPER, P.C., P.O. BOX 2266 EADS STATION, ARLINGTON, VA, 22202, US

(73) Assignee: Cornell Research Foundation, Inc., Ithaca, NY (US)

(21) Appl. No.: 11/571,473

(22) PCT Filed: Jun. 22, 2005
(86) PCT No.: PCT/US05/21790

§ 371 Date: Dec. 29, 2006

Related U.S. Application Data
(60) Provisional application No. 60/584,124, filed on Jul. 1, 2004.

(51) Int. Cl. C40B 40/08; C40B 60/06; C40B 50/18

(52) U.S. Cl. 506/17; 506/39; 506/32

(57) ABSTRACT

A portable, fully-automated, microchip including a DNA purification region fluidly integrated with a PCR-based detection region is used to detect specific DNA sequences for the rapid detection of bacterial pathogens. Using an automated detection system with integrated microprocessor, pumps, valves, thermocycler and fluorescence detection modules, the microchip is able to purify and detect bacterial DNA by real-time PCR amplification using fluorescent dye. The fully automated detection system is completely portable, making the system ideal for the detection of bacterial pathogens in the field or other point-of-care environments.

### CROSS-REFERENCE TO RELATED APPLICATIONS

This application claims the benefit, under 35 U.S.C. 119(e), of U.S. Provisional Application No. 60/584,124 filed Jul. 1, 2004, the contents of which are incorporated herein by reference.

### STATEMENT REGARDING FEDERALLY SPONSORED RESEARCH OR DEVELOPMENT

This invention was made with Governmental support from the Alliance for Nanomedical Technologies, USDA Grant #03-35201-13691 and FDA Grant #06000002499A. The Government has certain rights in the invention.

### BACKGROUND OF THE INVENTION

1. Field of the Invention

The present invention relates to a microchip having a DNA purification region integrated with a PCR-based detection region. The use of the present microchip provides for the purification of DNA from a variety of samples, followed by an on-chip PCR reaction that can be monitored by fluorescence.

2. Description of Related Art

In the past decade there has been an increased demand for rapid and accurate methods of detecting pathogenic bacteria, viruses and other disease-causing agents. In response to these demands, biosensors have been developed utilizing a variety of existing semiconductor processing strategies. The resulting devices, collectively known as lab-on-a-chip devices, incorporate multiple laboratory processes in a semi-automated, miniaturized format. Many of these devices utilize the polymerase chain reaction (PCR) which is relatively robust, however, a variety of contaminants can inhibit amplification and diminish the success of such analytical instruments. In order to circumvent this problem, DNA must be extracted and purified from a sample through a variety of lysis protocols and purification techniques.

One of the most common purification methods is chemical lysis followed by DNA purification using silica-based resins. DNA in chaotropic salt containing buffers, such as those containing guanidiunium or sodium iodide salt, preferentially binds to silica surfaces, while other macromolecules, such as proteins and lipids, remain in free solution. These unwanted components can be removed by various methods, including centrifugation and subsequent alcohol based washing steps. The relatively pure DNA is then eluted in low-ionic strength buffer or water. While this method is simple and kits are commercially available, they are based upon particulate matrices that present challenges in controlling flow rates and integration into chip-base devices. At least one group has reported the incorporation of silica-based resins into micro-flow device, while another group has used microfabricated silica pillar structures for the same purpose. Such a system eliminates the need for centrifugation by simply flowing samples and wash buffers through the resin with positive pressure.

Successful chip-based DNA purification and PCR requires not only manufacturing of the detection microchips, but also development of a platform to perform the necessary thermal cycling, fluorescent measurement and fluid control systems. In previous studies, several strategies have been used to fulfill these requirements. For PCR thermal cycling, multiple techniques have been employed, including infrared light, thermoelectric heater-coolers, and resistive electrodes. In addition to changing the temperature of the entire reaction chamber, other methods have used so-called “flow-through” PCR in which the sample is passed through different thermal regions on the chip. Moving fluids through micro analytical devices has also been a challenge. For bench-top applications, precise fluid control is often achieved with syringe pumps due to their high precision and ease of use. In addition to syringe pumps, the use of electroosmotic pumps, miniaturized peristaltic pumps and thermally-driven pumps have been reported. Electroosmotic pumps are intrinsically simple with few moving parts, but are highly dependent upon the geometry of the microchannels and the chemical composition of the fluid to be pumped. Both thermal and electroosmotic pumps are subject to bubble formation from thermal and electrolytic effects, respectively. Bubbles scatter light and can reduce the sensitivity of an instrument relying on optical detection. Miniaturized peristaltic pumps offer an alternative pumping strategy, but require complicated gas control systems for actuating the microfluidic valves. These systems, however, can be overly cumbersome for integration into a portable detection system.

In the field of fluorescence detection, there have been relatively few reports of miniaturized excitation and emission sources for microchip devices. Most devices utilize bulky, bench-top excitation sources, including lasers and mercury lamps. In addition, detection has commonly been accomplished with microscope-based CCD cameras or other large instruments that severely inhibit portability. In contrast to these larger systems, light emitting diodes (LEDs) have been used as excitation sources, combined with miniaturized detectors such as photodiodes and miniaturized photomultiplier tubes. An LED-based system for fluorescence excitation has been reported for a detection system. Because of its low power requirements, LED-based excitation is highly useful for portable analytical devices.

### BRIEF SUMMARY OF THE INVENTION

The present invention is directed to a method for microfabricating a microchip for the integrated purification of DNA and subsequent miniaturized, real-time polymerase chain reaction (PCR). The microchip is designed to purify DNA from a variety of samples, followed by an on-chip PCR reaction that can be monitored by fluorescence. In this way, the microchip can be used as a biosensor to detect specific DNA sequences, thereby identifying a variety of potential biological threats. This biosensor provides the integration of DNA purification and PCR onto a single microchip.

To better integrate purification schemes into a chip-based biosensor, the present invention focuses on the design and optimization of a microfabricated silica surface constructed utilizing standard photolithography and microfabrication techniques. Rather than filling microfluidic channels with silica resins or beads, the present invention provides silica surface during the microfabrication process. This circumvents problems associated with filling channels with binding matrices after microfabrication steps are completed. Additionally, this method can easily be coupled with standard microfabrication techniques, making it feasible to incorporate a purification module with other modules on the same chip. By integrating microfluidic devices onto single chips, many of the problems associated with external connections are avoided, such as fluid leakage and associated large dead volumes. The present microchip including a DNA purification region is both simple to fabricate and highly functional. The present invention also includes a simple, one-step process for disrupting bacterial cells and purifying chromosomal DNA for subsequent experimentation. These features of the present system provide a robust DNA purification device for integration with nucleic acid based biosensors.

Using microstructures, nucleic acids are selectively bound, washed and eluted for subsequent real-time PCR. These microstructures are integrated into a microchip containing two distinct regions: a DNA purification region and a PCR-based detection region for real-time PCR. Using an automated detection system including the microchip, an integrated microprocessor and a fluorescent detection module, the microchip purifies and detects bacterial DNA by real-time PCR amplification using fluorescent dye. A preferred automated detection system also includes an integrated syringe pump, a series of valves, and a thermoelectric heater cooler.

The present invention is directed to a microchip that provides the ability to selectively bind and release DNA utilizing microfabricated pillars in a simple microfluidic system that serves as the basis for a biosensor. Not only does the DNA remain intact and contaminant-free, as evidenced by PCR amplification, but the purification steps remove a significant amount of protein and other PCR inhibitory reagents, such as those used for cell lysis. The DNA that is eluted provides an excellent target for PCR amplification, but could also be used for a variety of other biosensor detection modules, including sequencing, electrophoretic separation and other forms of analysis requiring purified DNA. Because whole cells can be used as starting material, there are no complicated requirements for sample preparation. Similar lysis buffers have been successfully used for DNA preparation from blood as well as bacterial cells and should be effective for use in the present device as well. Prior devices that also utilized microfabricated silica pillars have not demonstrated an ability to extract and purify DNA from intact cells. In addition, other techniques using silica particles and sol-gel systems to purify DNA in microfluidic devices have presented problems for real-time application. Both of these methods provide excellent silica matrices for purifying DNA, but they present additional problems for device fabrication. Filling microfluidic channels with either sol-gel solutions or silica particles can be difficult and highly variable, producing inconsistencies between individual devices. By defining the silica structures through microfabrication in the present invention, the construction of the present devices has been simplified while retaining a high degree of control over their features. This results in highly reproducible devices that will consistently perform as expected. Such consistency simplifies optimization procedures and reduces the variability associated with other devices. The fabrication procedures used to construct the present device are standard in semiconductor processing and require minimal setup cost. By utilizing standard microfabrication technology, the DNA purification region is integrated onto the same microchip with a PCR-based detection region to provide high-quality DNA detection. The PCR-based microchip detector is constructed by combining the DNA purification region with on-chip fluorogenic PCR reactions, such as those utilizing TaqMan or SYBR Green. The present invention integrates the DNA purification region with a miniaturized thermocycler and microfluidic reaction chamber for the development of a PCR-based biosensor. This integrated approach to DNA purification and DNA amplification will likely prove to be paramount for the development of the next generation of biosensors for a variety of DNA-based detection schemes.

The microchip includes an integrated DNA purification region and a PCR-based detection region for bacterial detection. Although current PCR-based methods can be used to identify bacterial pathogens, such as Listeria monocytogenes and Bacillus anthracis most systems require manual nucleic acid extraction and sample preparation that is time consuming and requires multiple laboratory instruments. In an improvement over other systems, the present microchip presents a fully automated method of purifying DNA from bacterial cells and preparing samples for PCR-based detection. As reported herein, the present detection system is capable of detection approximately 10⁴ L. monocytogenes cells and <100 B. anthracis cells. The average time required for DNA purification using the present detection system is approximately 15 min, which combined with real-time PCR resulted in the detection of 10⁴ L. monocytogenes and <100 B. anthracis cells in 45 min to 1 hour. Manual purification could be more efficient and/or effective than obtained using the present microchip, but is more time consuming and less portable than the present automated detection. Conventional methods of detection, as outlined by the Bacteriological Analytical Manual, include cell culturing on microbiological media and require at least 24-48 hr for detection. In relation to other detection methods, the present microchip performs at high sensitivity, is faster and incorporates on-board sample preparation. The utility of the present detection system is capable of being extended to other organisms and incorporate alternative fluorogenic PCR techniques, including the 5′ nuclease assay.

### BRIEF DESCRIPTION OF THE SEVERAL VIEWS OF THE DRAWING(S)

The features and advantages of the present invention will become apparent from the following detailed description of a preferred embodiment thereof, taken in conjunction with the accompanying drawings, in which:

FIG. 1 shows a top view of a preferred microchip 2 including a DNA purification region 4 integrated with a PCR-based detection region 6 in accordance with the present invention;

FIG. 2 shows a side view of a preferred microchip 2 in accordance with the present invention;

FIG. 3 shows a preferred DNA purification region 4 with silica-coated pillars 22;

FIG. 4 shows a preferred detection system 30 with a preferred microchip 2 in accordance with the present invention;

FIG. 5 shows a preferred fluorescent detection module 42 including a PMT 64 in accordance with the present invention;

FIG. 6 is a DNA elution profile of bacteriophage Lambda DNA from 20 μm deep microfabricated device;

FIG. 7 is a graph showing DNA purification from 10⁷ E. coli cells including the removal of protein from the microchip (solid diamonds) during the washing phase and also the release of purified DNA (open squares) during the release/elution phase;

FIG. 8 is a graph of the temperature profile of a preferred microchip 2 for a standard cycling parameter used for real-time PCR in accordance with the present invention;

FIG. 9 shows gel electrophoresis data for DNA purification and real-time PCR amplification of L. monocytogenes on the microchip;

FIG. 10 is a graph showing DNA purification and real-time PCR amplification of various number of Listeria monocytogenes cells on the microchip 2;

FIG. 11 is a graph showing the real-time PCR for on-chip purification and PCR of Bacillus anthracis; and

FIG. 12 is a graph showing on-chip melting curve analysis of PCR products from the amplification of from 40 to 10⁶ B. anthracis cells.

### DETAILED DESCRIPTION OF THE INVENTION

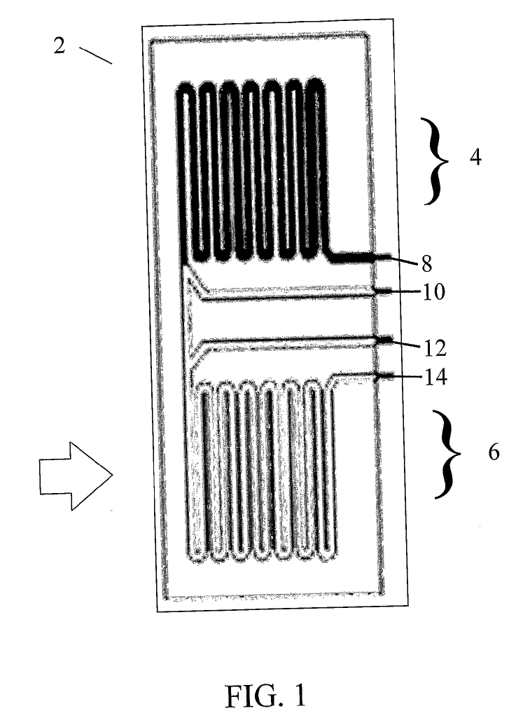

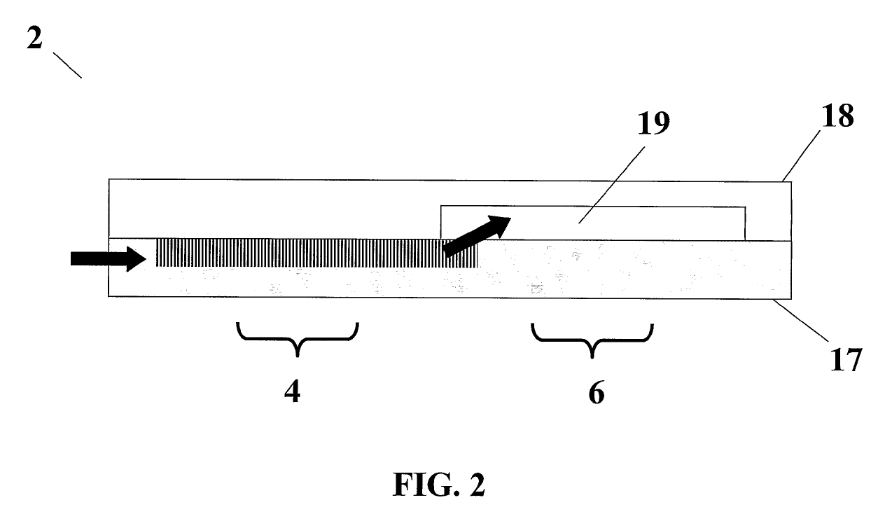

FIG. 1 shows a top view of a microchip 2 including a DNA purification region 4 fluidly integrated with a PCR-based detection region 6 according to a preferred embodiment of the present invention that is used for real-time detection of specific DNA sequences. Preferably the microchip 2 includes a series of fluid connections including, but not limited to, a sample input 8, a waste outlet 10, a PCR reagent input 12, and a reaction outlet 14. A large white arrow in FIG. 1 denotes a lateral path for fluorescent excitation for a real-time polymerase chain reaction (PCR). FIG. 2 shows a side view of the microchip 2 in a preferred embodiment of the present invention wherein the DNA purification region 4 is formed in a substrate 17, such as silicon, and capped with a capping structure 18, preferably formed from poly(dimethyl)siloxane (PDMS), including an enclosed PCR reaction chamber 19 in the PCR-based detection region 6. The arrows in FIG. 2 show the direction of flow of a sample containing the specific DNA to be detected.

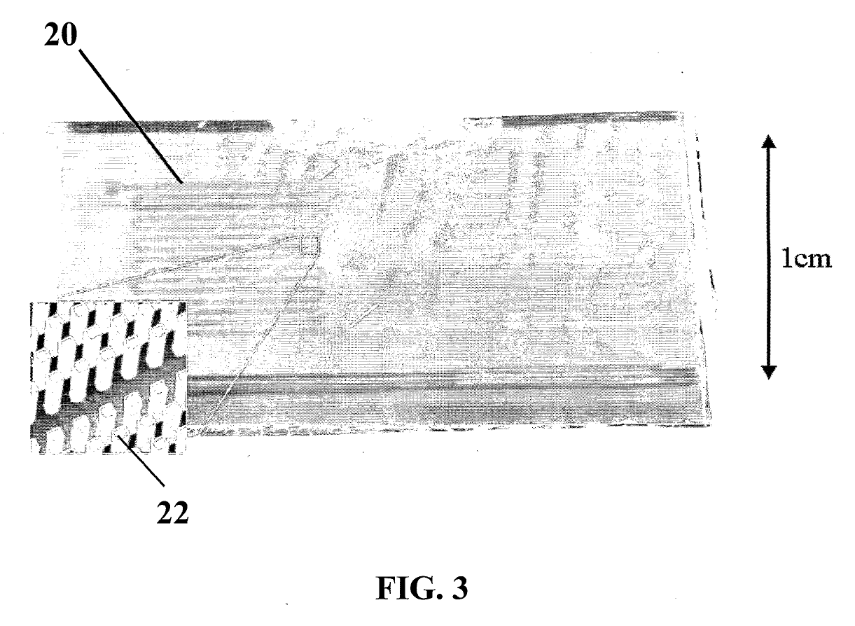

A preferred embodiment of the DNA purification region 4 is depicted in FIG. 3. The preferred DNA purification region 4 includes a microfabricated channel 20 in which a plurality of silica-coated pillars 22 are etched into a substrate 17, preferably a silicon wafer, to increase the surface area within the channel 20 by 300-600%. The etch depth of the channel 20 and height of the pillars 22 preferably varies from 20-50 μm. The spacing between pillars 22 and the pillar width is preferably kept constant at approximately 10 μm. The inset in FIG. 3 is an SEM micrograph of the channel 20 with the plurality of silica-coated pillars 22.

The capping structure 18 including the PCR reaction chamber 19 is preferably formed in poly(dimethyl)siloxane (PDMS) using photolithographically patterned SU-8 negative photoresist described by Xia and Whitesides in “Soft lithography”, Angew. Chem. Int. Ed. 37 (1998) 550-575, the contents of which are incorporated herein by reference. Briefly, PDMS is cured in an SU-8 mold of the PCR reaction chamber and then bonded to a thin PDMS membrane. Bonding is achieved by exposing both PDMS substrates to an oxygen plasma. After bonding, the capping structure 18 with an enclosed PCR reaction chamber 19 is bonded to the substrate 17 that has been previously fabricated. Stainless steel tubing is then preferably glued into access holes that have been molded into the capping structure 18 to be used as access points for fluid introduction and elution from the microchip 2.

Preferably, the microchip 2 is then washed with dH₂O and subsequently treated with bovine serum albumin (BSA) to passivate the interior of the microchip 2, facilitating PCR amplification. DNA purification is preferably accomplished using a chaotropic salt-containing lysis/binding buffer consisting of 4 M guanidinium-HCL. This buffer is used to break open bacterial cells and bind DNA to the microfabricated pillars 22. The bound DNA on the pillars 22 is then washed with an ethanol-containing buffer to remove unwanted material such as protein and lipids. DNA is preferably released from the pillars 22 with dH₂O and is used for real-time PCR by mixing with pre-mixed PCR buffer forming a PCR reaction mixture. The PCR buffer preferably includes 2× concentration PCR master mix, forward and reverse oligonucleotide primers, and water to dilute the mixture to the appropriate concentration. This PCR reaction mixture is pumped into the PCR reaction chamber 19 and is subjected to thermal cycling with an external thermoelectric cooler (TEC). Real-time PCR reactions are monitored with a fluorescent detection module including a photomultiplier tube (PMT) detector.

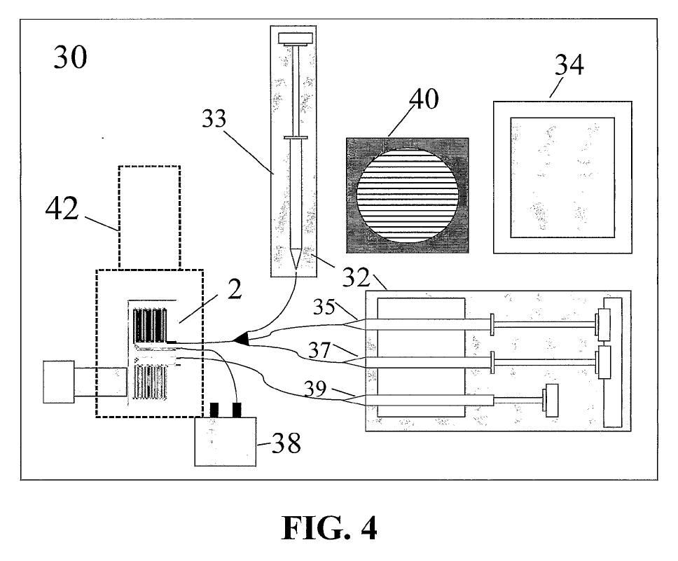

FIG. 4 is a schematic of a preferred detection system 30 including the microchip 2, an integrated syringe pump 32, an integrated microprocessor 34, a micro valve 38, a cooling fan 40, a fluorescent detection system 42 including a PMT detector, and a thermoelectric heater cooler (not shown). The microchip 2 is inserted into the detection system 30 directly above the thermoelectric heater cooler. The entire detection system 30 preferably measures 36 cm×28 cm×15 cm. The integrated syringe pump 32 preferably drives material from a sample syringe 33, a wash buffer syringe 35, a dH₂O syringe 37, and a PCR mixture syringe 39. The syringes 33, 35, 37, 39 are preferably connected to the microchip 2 via Tygon™ tubing. The detection system 30 automates fluid handling and controls thermal cycling operation.

During operation, the entire detection system 30 is preferably controlled by the integrated microprocessor 34 and is programmed to carry out the amplification steps sequentially. In order to provide accurate fluid control and movement throughout the system, the integrated syringe pump 32 is preferably a multiple-channel syringe pump designed to allow for parallel pumping of multiple fluids. A single stepper motor preferably actuates this pump that can drive individual syringes by selective engagement using electromagnetic clutches. Fluid flow direction and chip pressurization are preferably controlled by the micro valve 38. The temperature of the detection microchip is preferably cycled by the thermoelectric heater cooler (TEC) that is, in turn, controlled by a TEC control chip and control board. A 10 kΩ thermistor mounted below the microchip 2 preferably measures the temperature and is used as the feedback element by the integrated microprocessor 34 to control cycling parameters. The integrated microprocessor 34 preferably includes a control board that is modified so that three separate temperature set-points could be achieved by switching between temperature set-point resistors with relay switches.

In order to provide an accurate fluid control and movement throughout the detection system 30, a multi-channel syringe pump is preferably used for parallel pumping of multiple fluids. In a preferred embodiment, a single Faulhaber AM1525-15A 102:1 HEAM152412 stepper motor (MicroMo, Clearwater, Fla.) actuates the pump that can drive individual syringes by selective engagement using PIC Design, Inc. PW1-333 electromagnetic clutches (Middlebury, Conn.). The pump is preferably capable of pumping at flow rates from 1.7-50 μl/min.

In a preferred embodiment, the micro valve 38 is electrically actuated and is preferably from Moog (East Aurora, N.Y.) to direct fluid flow and pressurize the system 30 in preparation for thermal cycling. This is important for switching the direction of fluid flow between purification and PCR procedures on the microchip 2 and for preventing bubble formation during thermal cycling. Without pressurization, dissolved gasses and microscopic bubbles in the reaction mixture can increase in volume, especially during the 95° C. portion of the PCR thermal cycling. This results in bubble formation, causing increased light scattering that degrades the fluorescent signal from the real-time PCR reaction. Pressurization above 1 atm reduces gaseous volume changes at high temperatures, preventing bubble formation.

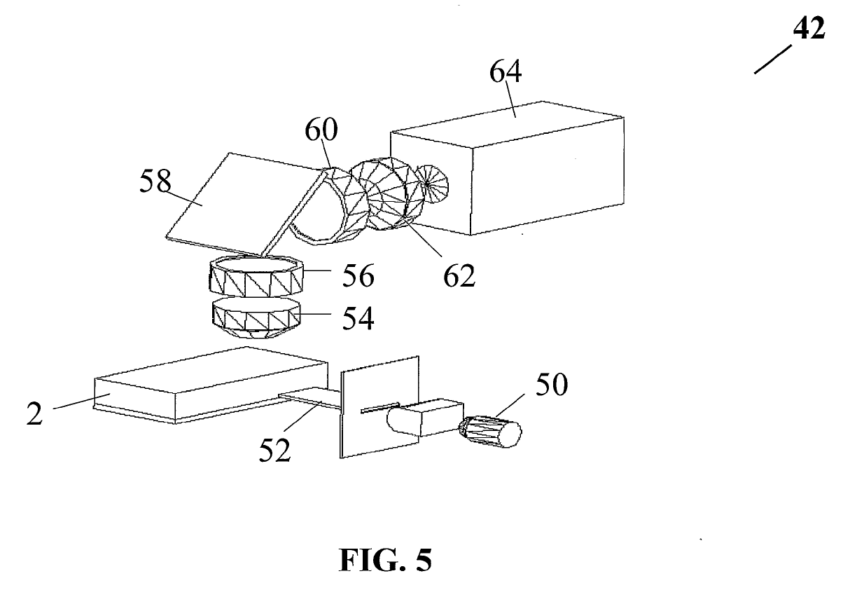

As shown in FIG. 5, optical detection for real-time PCR is preferably achieved using the fluorescent detection module 42. In a preferred embodiment, the fluorescent detection module 42 is similar to a system described by Dasgupta, et. al., entitled “Light emitting diode based detectors absorbance, fluorescence, and spectroelectrochemical measurements in a planar flow-through cell”, Anal. Chem. Acta 500 (2003) 337-364, the contents of which are incorporated herein by reference. A light emitting diode (LED) 50 preferably illuminates the PCR-based detection region 6 of the microchip 2 through a glass waveguide 52. Upon fluorescence of the real-time PCR reaction mixture, the emitted wavelengths are preferably passed through a first plano-convex lens 54 and filtered through a first band pass filter 56. The light is then preferably reflected by a mirror 58 through a second filter 60 and a second plano-convex lens 62 and into a photomultiplier tube (PMT) 64 for quantification of fluorescence intensity.

Additionally, remote communication interfaces may be added with the detection system and microchip. Preferably, such interfaces include wired and wireless Ethernet, modem to connect with a wireless cell phone, land line phone, and a GPS-based location unit. These capabilities would enable the instrument to be deployed as a part of a networked cluster monitoring system. Such a system can then gather data from geographically diverse areas and provide data to a central unit. It would be possible to identify the extent and region of any disease outbreak.

### EXPERIMENT 1

### DNA Purification Only

In order to initially test the DNA purification of the microchip, a microchip was fabricated that only contained the DNA purification region and did not contain a PCR-based detection region. Briefly, 4 in. silicon wafers were spin coated with Shipley 1813 photoresist (Marlborough, Mass.) and patterned using a GCA 6300 5×g-line optical stepper (Costs Mesa, Calif.). The exposed photoresist was developed and the wafers were plasma etched in a Unaxis SLR 770 reactive ion etcher (St. Petersburg, Fla.) to either 20 or 50 μm deep. After etching, 100 nm of silicon dioxide (silica) was deposited on the wafers through plasma enhanced chemical vapor deposition (PECVD) using a GSI Ultradep system (San Jose, Calif.). Wafers were subsequently cleaned in acetone to remove excess photoresist. Corning 7740 (Corning, N.Y.) glass covers were prepared for this microdevice by drilling 0.75 mm holes with a diamond tipped drill. The covers were then cleaned, along with the silicon wafers, in 5:1:1 (dH₂O:H₂O₂:N—H₄OH) and finally rinsed with dH₂O. The glass covers were anodicially bonded to the prepared devices using −500 V at 350° C. in an Electronic Visions EV 501 Bonder (Cranston, R.I.). After bonding, stainless steel tubing was inserted into the holes in the glass covers and was glued in place using Miller-Stephenson 907 Epoxy (Danbury, Conn.). Connections between the tubing and the syringe pump were made using Teflon tubing, joined to 28 gauge needles. In this way, fluid could be forced through the device using positive pressure.

Intact bacteriophage lambda DNA was obtained from New England Biolabs (Beverly, Mass.) and was diluted in TE buffer to 100 ng/μl. Lambda DNA preparations of different concentrations were made by adding this stock solution to L6 buffer (5M guanidinium isothiocyanate (GuSCN), 0.2M EDTA and 0.7% Triton X100 in 0.1M Tris HCl, pH 6.4). Cell lysates were prepared from E. coli TOP10 cells from Invitrogen (Carlsbad, Calif.). The cells were grown in LB broth at 37° C. to an optical density at 600 nm of 2.0 and their concentration was confirmed by serial dilution and plating onto LB agar plates. Cells were centrifuged at 8,000×g for 2 minutes and resuspended in phosphate buffered saline buffer (PBS). Cell lysis was performed by adding 75 μL of 1.3×10⁵ to 1.3×10⁸ cfu/ml of cells to 225 μl of L6 buffer and incubating for 10 minutes at room temperature. All of the above chemical reagents were obtained from Sigma (St. Louis, Mo.).

Fluids were pumped through the device using a KD Scientific (New Hope, Pa.) syringe pump that could be adjusted to pump at flow rates of 0.5 μl/min to 10 ml/min. Although the fluid pressure was not directly measured for these experiments, flow rates were varied from 2-10 μl/minute without leakage. Fluids were pumped into the device via a syringe connected to the input tubing and 50 μl eluted fractions were collected from the output in 0.5 ml tubes. Initially, 200 μl of TE buffer (10 mM Tris-HCl, 1 mM EDTA, pH 8.0) was pumped through each device to wash and preload it with buffer. After washing, 100 μl of DNA preparations were introduced, followed by 200 μl of 70% ethanol to wash away proteins and/or other contaminants. Finally, DNA was eluted by the addition of TE buffer in 50 μl volumes. DNA and protein in the eluted fractions was quantified using PicoGreen and CBQCA reagents, respectively, from Molecular Probes (Eugene, Oreg.). For DNA quantification, collected fractions were diluted 1:4 in TE buffer and an equal volume of PicoGreen reagent was added prior to fluorescence measurement. For CBQCA quantification of protein, 5 μl of each collected fraction was added to 145 μl of the CBQCA reagent mixture, followed by shaking for 1 hour at room temperature. These samples were prepared in Corning Costar half volume 96-well plates (Corning, N.Y.) and were quantified in a microplate fluorimeter (Tecan, Durham, N.C.). Standard curves for DNA and protein were generated using phage lambda DNA and bovine serum albumin (Molecular Probes, Eugene, Oreg.). Fluorescence measurements were made using the recommended excitation and emission wavelengths for each reagent.

PCR amplification of nucleic acid targets was carried out using standard protocols. A 500-bp fragment from lambda DNA was amplified using primers previously reported by Tian, et. al (2000) in “Evaluation of silica resins for direct and efficient extraction of DNA from complex biological matrices in a miniaturized format”, Analytical Biochemistry 283, 175-191. A 910-bp fragment of the lactate dehydrogenase gene, ldhA (Genebank Accession Number U36928), was amplified from E. coli chromosomal DNA using the following primers: LdhAFor: 5′-AGAAGTACCTGCAACAGG-3′ LdhARev: 5′-TTGCAGCGTAGTCTGAG-3′. PCR reactions consisted of 25 μl Bioline (Amherst, Mass.) BioMix PCR master mix, 50 nmol of each primer, 2 μl of collected fractions, in a total volume of 50 μl. These reactions were cycled in an MJ Research thermocycler (Waltham, Mass.) under the following conditions: 95° C. denaturation for 5 minutes, 35 cycles of 95° C. for 20 seconds, 68° C. for 30 seconds, 72° C. for 30 seconds, followed by a 5 minute extension at 72° C. DNA amplification was confirmed by gel electrophoresis.

### Experimental Results.

In order to characterize the binding capacity of the device, purified bacteriophage lambda DNA was used. Various amounts of lambda DNA, ranging from 10 ng to 1 μg, were mixed with L6 buffer and pumped through 20 μm deep devices after an initial wash with TE buffer. The DNA was then washed with 200 μl of 70% ethanol and finally eluted with 50 μl volumes of TE buffer. Solutions were pumped through the devices and collected in 50 μl fractions which were assayed for DNA concentration. No DNA was detected during the initial washing phase of the experiment, as was expected. During the loading of DNA and washing steps, less than 500 pg of DNA was detected per collected fraction. This is to be expected since the total amount of DNA introduced was less than the binding capacity of the device for most experiments. On average, 10% of the total DNA loaded was eluted in the first 50 μl of TE buffer for the various amounts of DNA tested. As a comparison, 10 ng of lambda DNA was processed through Qiagen QIAprep spin columns (Valencia, Calif.) using the same reagents and sample volumes as used with the present device. For these columns, the average amount of DNA eluted in the first 50 μl of TE buffer was 16% of the initial 10 ng loaded. From these data, it was clear that microfabricated silica-covered pillars were capable of selectively binding and releasing DNA with an efficiency similar to that of silica resins.

Collected fractions from the initial washing of the device and from the eluted DNA fractions were amplified by PCR to ensure that no inhibitory compounds were present. A 500 bp fragment of the Lambda chromosome was successfully amplified from each 50 μl fraction collected during DNA elution with TE buffer. This suggests that the eluted DNA was purified sufficiently for subsequent enzymatic reactions and that PCR inhibitors, such as the GuSCN binding buffer, did not contaminate the eluted DNA. PCR amplification was unsuccessful with fractions from the ethanol wash steps, which may have been due to the presence of residual ethanol or an insufficient amount of target DNA.

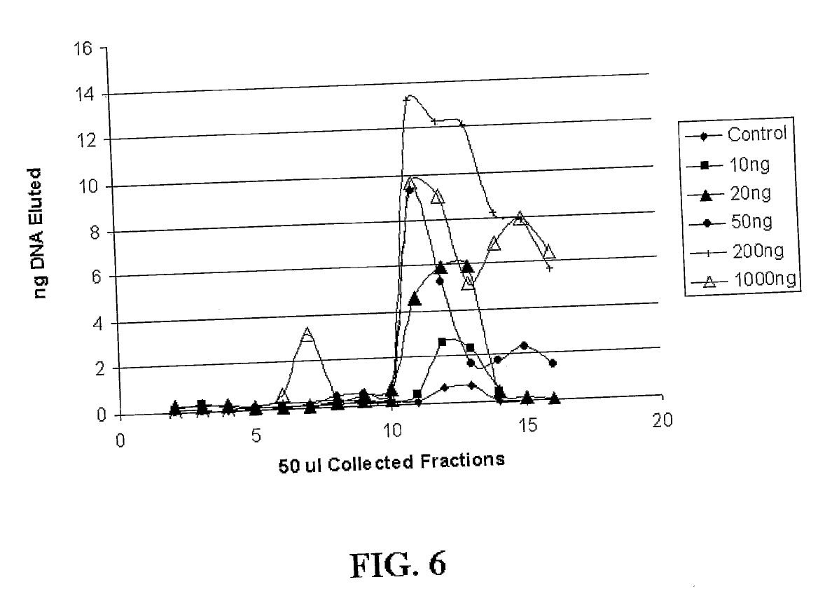

To test the binding capacity, various quantities of lambda DNA were applied to the device and DNA was quantified from the collected fractions. As can be seen from FIG. 6, fractions containing up to 200 ng of lambda DNA bound completely to the device and DNA was not detected in the ethanol wash fractions. When 1000 ng of DNA was loaded, however, a small portion (3 ng) of DNA was detected in the ethanol wash fractions, suggesting that the silica pillars had been fully saturated with DNA. For these reasons, it appears that the binding capacity of these devices is between 200 and 1000 ng of DNA, with a maximum DNA elution in the first 50 μl fraction of approximately 9-13 ng. With a device binding capacity of around 200 ng of DNA and a total internal surface area of 2.45 cm², the binding capacity of the silica used was approximately 82 ng/cm². This does not take into account any surface roughening introduced by the etching technique used, which could effectively increase the total internal surface area of the device.

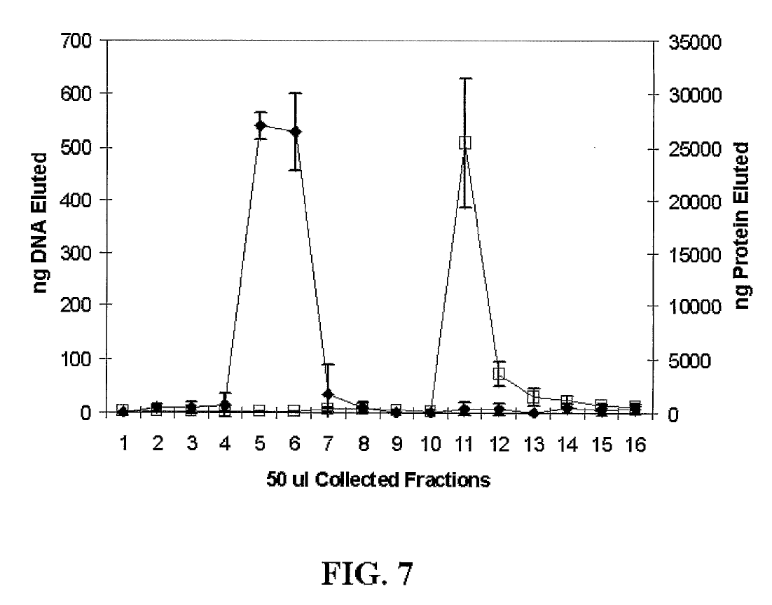

Since Lambda DNA was selectively bound and released from microfabricated silica pillars this suggested that bacterial DNA could be purified as well. Purification of nucleic acids from cells requires not only lysis to release DNA, but additional steps to remove unwanted cellular components such as proteins and lipids. Removal of unwanted components is often necessary for subsequent processes such as PCR, since inhibitory compounds are often found in growth media and/or the cell lysate. A previous study showed the binding buffer, L6, containing the protein denaturant, GuSCN, as well as the detergent, Triton X100 could also lyse bacteria. This facilitated a one-step procedure for cell lysis and DNA binding. For these experiments, 1×10⁷ cells were added to L6 buffer, incubated for 10 min, and then 100 μl of this lysate was applied to 50 μm deep devices. As shown in FIG. 7, DNA was only detected in fractions 11-16. Most of the DNA (77%) was eluted in the first 50 μl of TE buffer at an average concentration of 10 ng/μl. This amount of DNA is well within the detection limits of PCR-based assays. For the three devices tested in this experiment, each produced similar elution profiles, yielding consistent amounts of DNA. For the first elution of DNA in TE buffer (FIG. 7, collected fraction #11), the three devices yielded 442, 434 and 645 ng of DNA, respectively. For the first two devices, this represents a mere 2% variation in the amount of DNA that was eluted, suggesting a high degree of consistency between individual devices. To determine if the DNA was actually being purified, the protein concentration was also quantified for each collected fraction. Although initially high, the protein concentration decreased rapidly after the initial loading and washing steps as shown in FIG. 7. Fewer than 8 ng/μl of protein were present in the final fractions, as compared to the 60 ng/μl present in the initial cell lysate. This represents removal of approximately 87% of the protein from the cell lysate. Prior studies have obtained between 80% and 90% removal of proteins with a system utilizing silica particles as a binding matrix and GuHCl solution as the binding buffer. This suggests that the microfabricated pillars in the present device is comparable to particulate silica for this type of purification.

### EXPERIMENT 2

### Microchip DNA Purification and Real-Time PCR Detection

A microchip 2 in accordance with the present invention is provided for the detection of the pathogens Listeria monocytogenes and Bacillus anthracis. These organisms are Gram positive bacterium that have been responsible for several disease-causing outbreaks in the past decade. Although L. monocytogenes is rarely lethal to healthy adults, it is highly virulent in the elderly, newborns, immuno-compromised individuals and pregnant women. Because this organism is a current threat to food safety, it is an ideal organism to use for model studies of the portable detection system 30 described herein. B. anthracis is the causative agent of Anthrax and has been shown to cause acute respiratory and cutaneous disease in humans and livestock. Previous studies have demonstrated real-time PCR-based detection of these organisms, using stationary laboratory equipment with high accuracy and sensitivity, can provide detection limits as low as 10 cells.

### Reagents.

Phosphate buffered saline (PBS), pH 7.4, guanidinium isothiocyanate (GuSCN), 70% ethanol (EtOH), ethylenediaminetetraacetic acid (EDTA), Sigmacote, Triton X-100, Tris (Trizma base), and SYBR Green JumpStart Taq ReadyMix, were obtained from Sigma-Aldrich (St. Louis, Mo.). Bovine serum albumin (BSA) 10 mg/mL and bacteriophage Lambda DNA (500 μg/mL) were obtained from New England Biolabs (Beverly, Mass.). SureStart Taq DNA polymerase (5 U/uL) was obtained from Stratagene (La Jolla, Calif.). BioMix PCR master mix and Hyperladder I DNA ladder were obtained from Bioline (Randolph, Mass.). Sylgard 184 poly(dimethyl) siloxane elastomer kits were obtained from Ellsworth Adhesives (Germantown, Wis.). Tryptic soy broth, brain-heart infusion, and Bacto™ agar were obtained from BD Difco (Franklin Lakes, N.J.).

### Bacterial Growth and Preparation.

Listeria monocytogenes and Bacillus anthracis cultures were grown in brain-heart infusion (BHI) and tryptic soy broth (TSB), respectively at 37° C. for 12 hr and were serially diluted in PBS. Enumeration of L. monocytogenes and B. anthracis was performed by plating serially diluted cultures onto BHI and tryptic soy (TSA) agar plates and determining the number of colony forming units (CFU) after 12 hr incubation at 37° C. For integrated DNA purification and PCR using the microchip, L. monocytogenes cells were first diluted in PBS to achieve various cell concentrations. Cell lysis was then achieved by mixing 90 μl of lysis buffer L5 with 10 μl of cells and incubating at room temperature for 5 min. This lysate was then pumped into the microchip using the integrated syringe pumps.

### PCR Amplification.

PCR amplification of nucleic acid targets was carried out using standard protocols, such as those described in Ausubel et al., 1994, “Current Protocols in Molecular Biology”. A 544-bp fragment from the Listeria monocytogenes hlyA gene was amplified using primers HLYP8 and HLYP4R previously reported by Norton, et. al. in “Dectection of viable Listeria monocytogenes with 5′ nuclease PCR assay”, Appl. Environ. Microbiol. 65 (1999) 2122-2127. A 152 bp fragment of the B. anthracis chromosome was amplified using Ba813R1 and Ba813R2 primers previously described by Fasanella, et. al. (Vaccine. 19 (2001) 4214-4218). PCR reactions consisted of 25 μl SYBR Green JumpStart Taq Ready Mix (Sigma, St. Louis, Mo.), 50 nmol of each primer, 1 μl template DNA, in a total volume of 50 μl. Reactions were cycled in an MJ Research thermocycler (Waltham, Mass.) under the following conditions: 95° C. denaturation for 5 min, 40 cycles of 95° C. for 10 seconds, 57° C. for 15 seconds, 72° C. for 20 seconds, followed by a 5 min extension at 72° C. DNA amplification was confirmed by gel electrophoresis. Real-time PCR was performed on an ABI Prism 7000 real-time thermocycler (Applied Biosystems, Foster City, Calif.). For these experiments, various amounts of template DNA were used in the same reaction conditions as described above. Microchip-based PCR amplification was performed using the same reaction conditions and fluorescence was monitored during the 72° C. extension step of each cycle. For optimized microchip PCR, SYBR Green JumpStart Ready Mix was mixed at 1.35 times the standard concentration for a 50 μl reaction: 25 μl Ready Mix, 50 nmol each primer, 2.5 units Stratagene Sure Start Taq polymerase (La Jolla, Calif.), and dH₂O to a final volume of 37.5 μl.

### Microchip Design and Fabrication.

The microchip described herein incorporates a microfabricated DNA purification region with a second PCR-based detection region, connected by microfabricated channels. The DNA purification region 4 contains an array of 10 μm square pillars 22 that were etched 50 μm deep in a silicon wafer to form a microfabricated channel 20. Briefly, 4 in. silicon wafers were spin coated with Shipley 1813 photoresist and patterned using a GCA 6300 5× g-line optical stepper (Costa Mesa, Calif.). The exposed photoresist was developed and the wafers were plasma etched in a Unaxis SLR 770 reactive ion etcher (St. Petersburg, Fla.) to either 20 or 50 μm deep. After etching, 100 nm of silicon dioxide (silica) was deposited on the wafers through plasma enhanced chemical vapor deposition (PECVD) using a GSI Ultradep system (San Jose, Calif.). Wafers were subsequently cleaned in acetone to remove excess photoresist.

The PCR-based detection region 6 was constructed using multiple techniques, involving various methods. The chips used for testing were constructed using soft lithography techniques for poly(dimethyl siloxane) (PDMS) and SU-8 photoresist (Microchem, Newton, Mass.) described by Xia, et al, in “Soft lithography”, Agnew. Chem. Int. ed. 37 (1998) 550-575. Briefly, PDMS was cured in an SU-8 mold of the PCR chamber and then bonded to a 50 μm thick PDMS membrane. Bonding was achieved by exposing both PDMS substrates to an oxygen plasma for 20 sec in a Harrick (Ossinning, N.Y.) Plasma Cleaner/Sterilizer. The PDMS substrates were then pressed together and baked at 60° C. for 30 min to achieve maximum bonding strength. After bonding, the PDMS structures were peeled from the wafer and were bonded to the microfabricated silicon wafer to seal the chambers. For fluidic connections 30 ga. stainless steel tubing was inserted into holes in the PDMS and was glued in place using Miller-Stephenson 907 Epoxy (Danbury, Conn.). Connections between the tubing and the syringe pump were made using 0.010 in. microbore tubing (Small Parts, Miami Lakes, Fla.).

### Detection System.

An integrated microprocessor 34 was built to automate fluid handling and control thermal cycling operation. The system was designed to require low power (20 W) and occupy a small footprint for future development of a portable, point-of-care device. The instrument has an electronics module consisting of a controller board and power amplifiers for driving an automatic, integrated syringe pump 32, a thermoelectric heater/cooler, a fluorescent detection module 42, and a pressure valve. During operation, the entire system is controlled by a Rabbit Z-world microcontroller board (Davis, Calif.) and is programmed to carry out the amplification steps sequentially. In order to provide accurate fluid control and movement throughout the system, a multiple-channel syringe pump was designed to allow for parallel pumping of multiple fluids. A single Faulhaber AM1525-15A 102:1 HEAM152412 stepper motor (MicroMo, Clearwater, Fla.) actuates this pump that can drive individual syringes by selective engagement using PIC Design, Inc. RW1-333 electromagnetic clutches (Middlebury, Conn.). Fluid flow direction and chip pressurization are controlled by a Moog MicroValve (East Aurora, N.Y.).

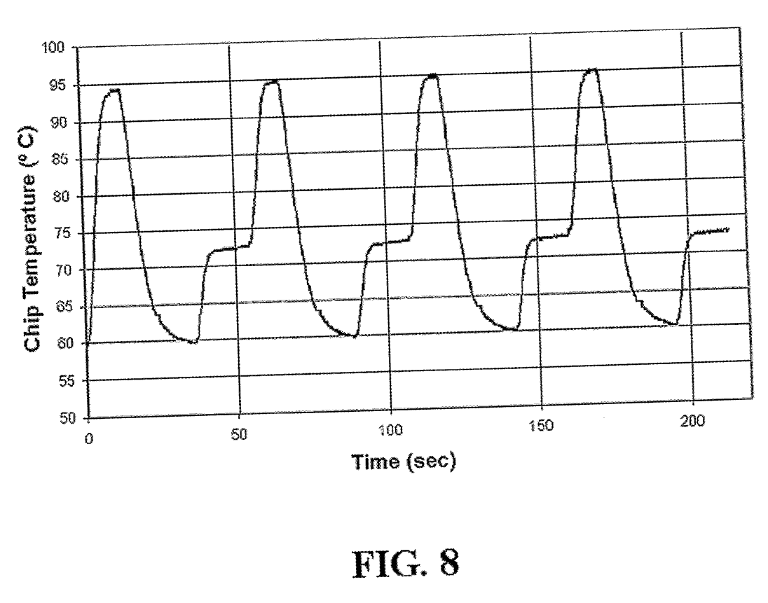

The temperature of the microchip is cycled by a Melcor HOT 2.1-31-F2A (Trenton, N.J.) thermoelectric heater/cooler (TEC) that is, in turn, controlled by a Hytek (Carson City, Nev.) 5640 TEC control chip and Hytek 5670 control board. A 10 kΩ thermistor mounted on the chip measures the temperature and is used as the feedback element by the microcontroller to control cycling parameters. The Hytek 5670 control board was modified so that three separate temperature set-points could be achieved by switching between temperature set-point resistors with relay switches. The typical temperature profile during a thermocycling procedure is shown in FIG. 8.

Optical detection for real-time PCR was achieved using an LED-based fluorescent detection module 42 and miniaturized photomultiplier tube (PMT) 64 for detection. The fluorescence detection module 42 both excites and detects fluorescence in PCR microchips during amplification reactions and is similar to a system described by Dasgupta, et. al., in “Light emitting diode-based detectors absorbance, fluorescence, and spectroelectrochemical measurements in a planar flow-through cell”, Anal. Chem. Acta 500 (2203) 337-364, which is incorporated herein by reference. The sample is excited by a 480 nm blue light emitting diode (LED) requiring 80 mW of power. The LED is filtered using a Chroma Inc. D480/30× excitation filter and laterally excites the detection microchip through a chrome-coated glass waveguide. The resulting fluorescence is filtered by two Chroma Inc. (Rockingham, Vt.) D535/40 m emission filters and detected by a Hamamatsu (Bridgewater, N.J.) H5784-20 photomultiplier tube (PMT) at 520 nm. The light from the LED uniformly illuminates the detection region on the chip while the PMT detects the fluorescent emission. Plano-convex lenses were used to focus emitted light from the detection microchip through the first emission filter, off of a 45° mirror, through a second emission filter and into the PMT. The following specification describes the optical parameters of the system. The clear aperture for imaging the reaction chamber is 6.46 mm in diameter which is 33% of the area of the 10 mm square chamber. This translates into a 6.46 mm spot size at the focal point. The numerical aperture (of the objective lens) is 0.41 and has a working F-number of 0.925. The depth of focus (DOF) for the microfluidic channels was calculated to 574 μm. The microfluidic channels of the PCR chamber are 100 μm in height, well within the depth of focus. The image size on the PMT is 4.92 mm in diameter and the image NA is 0.54. The magnification for the system is 0.75×.

The entire system is mounted in a portable box enclosure that measures 36 cm×28 cm×15 cm and has a total weight of 4 kg. During a typical detection protocol, a program is loaded into the Z-world controller's flash memory from a laptop computer through serial inputs. The program executes fluid pumping, chip pressurization, thermal cycling, and fluorescence detection sequentially. During the real-time PCR reaction, fluorescence data is collected during the 72° C. extension step and is either stored in the microcontroller's flash memory or is directly output to a laptop computer.

### Integrated Microchip Performance.

The integrated microchip was designed to perform automated DNA purification and real-time PCR in a self-contained system. Individual components of the instrument were characterized separately. During testing, the pump was shown to be capable of pumping at flow rates from 1.7 μl/min to 50 μl/min. Fluid flow rates were determined by pumping fluids into 50 μl graduated glass microcapillaries at known motor stepping frequencies for a given length of time. After the flow rate calibration of the instrument, the on-board microprocessor was used to drive the pump at known frequencies and times making it possible to determine volumetric accuracy in the graduated microcapillary tubes. The accuracy of the pumping rate was measured to be +/−0.1 μl/min. An electrically actuated microvalve from Moog (East Aurora, N.Y.) was used to direct fluid flow and pressurize the system in preparation for thermal cycling. This is important for switching the direction of fluid flow between purification and PCR procedures on the chip and for preventing bubble formation during thermal cycling. During testing of the fluidic system, the entire sample preparation procedure, including DNA purification, DNA elution and chip pressurization took approximately 15 min. The on-board TEC-based thermocycler was tested for its ability to rapidly and accurately cycle between the necessary temperatures for PCR. The average heating and cooling rates for this thermocycler were both 3.1° C./sec as shown in FIG. 8. Using cycling parameters of 95° C. for 10 sec, 57° C. for 15 sec and 72° C. for 20 sec, an entire 40 cycle reaction could be completed in 35 min. In comparison, the ABI Prism 7000 real-time thermocycler that was used for validation experiments required 1 hour and 20 min while using the identical cycling parameters, nearly 4 times longer than the present system. Combined with the 15 min needed for sample preparation, the entire process of preparation and detection took only 45 min to 1 hour min with the present system. A similar portable device reported by Liu, et al required 3.5 hr for the detection of 10³ Escherichia coli cells. In addition to being fast, the instrument is rated at 20 watts, which can be provided by a standard rechargeable laptop computer battery.

### Bacterial Detection.

In order to use the present detection system for bacterial detection, on-chip purification of L. monocytogenes and B. anthracis DNA was performed followed by on-chip real-time PCR. After cell lysis and DNA binding, as described previously, dH₂O was pumped into the purification region to recover DNA for amplification in the PCR chamber. Simultaneous pumping of a concentrated PCR master mix through a second input port allowed for parallel flow of eluted DNA and master mix into the amplification chamber. By varying the pumping speeds of these two fluids, they could be pumped into the amplification chamber in a volumetric ratio that yielded the appropriate final concentration of the master mix. A variety of concentrations and pumping speeds were explored, yielding a final master mix concentration of 1.35 times the normal concentration (see experimental section) and a pumping speed ratio of 3:1, where master mix was pumped at 3 μl/min, while dH₂O was pumped at 1 μl/min.

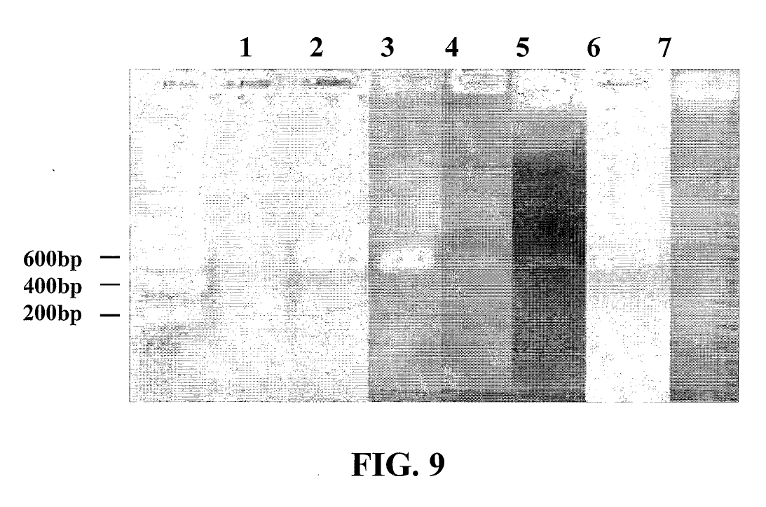

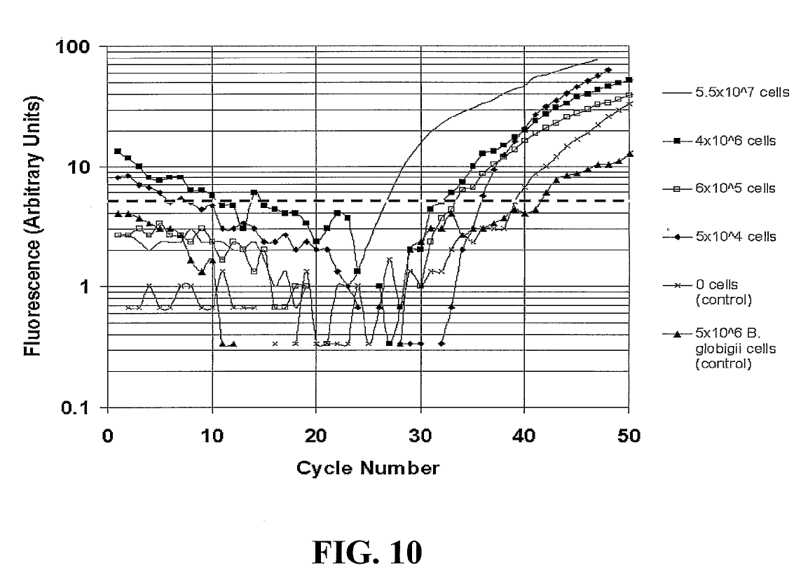

To explore bacterial detection sensitivity in the present device, decreasing numbers of L. monocytogenes and B. anthracis cells were used for on-chip DNA purification and real-time PCR. Using the modified DNA elution and mixing method described above, lysed cells were pumped into microchips for DNA binding and washing with 70% EtOH, followed by elution into the PCR amplification chamber. During DNA elution with dH₂O, Sigma JumpStart master mix with L. monocytogenes hlyA or B. anthracis Ba813 primers was pumped into the amplification chamber in parallel and the entire system was pressurized to prevent bubble formation during thermal cycling. The microchips were then thermally cycled for 50 cycles using the same parameters described for purified DNA reactions. Fluorescence measurements were made during the amplification phase of each cycle and completed reactions were analyzed by gel electrophoresis to confirm amplification of the appropriately sized fragment (See FIG. 9). PCR reactions were removed from the microchip after on-chip detection and were run on an agarose gel to ensure amplification of the intended DNA sequence The fluorescence results were normalized as described above and a threshold of 5 fluorescence units was used to determine CT values. As shown in FIG. 10, DNA was purified and detected with real-time PCR, between 10⁷ and 10⁴ L. monocytogenes cells. Attempts at detecting 103 and fewer cells were unsuccessful as determined by real-time fluorescence data and gel electrophoresis of completed reactions. Several control reactions were performed using B. globigii cells and L. monocytogenes hlyA PCR primers. A negative control using lysis buffer without cells was also performed. For these controls, the entire microchip purification and real-time PCR was performed for accurate comparison to the positive controls. These negative controls provide evidence that the threshold cycle for a positive result must be less than 40 cycles. Both the no-cell and B. globigii controls exhibited increases in fluorescence after 40 cycles as shown in FIG. 10. This is common for real-time PCR reactions using SYBR Green and is thought to be due to formation of primer-dimers and non-specific amplification of DNA. This was confirmed by performing gel electrophoresis of the negative control samples in which streaks of both high and low molecular weight DNA were observed. Because SYBR Green binds to any double stranded DNA, a non-specific increase in dsDNA can give rise to fluorescence and potential false-positive results. Therefore, the effective limits of detection for this system are limited to reactions that reach the threshold fluorescence level within 40 cycles.

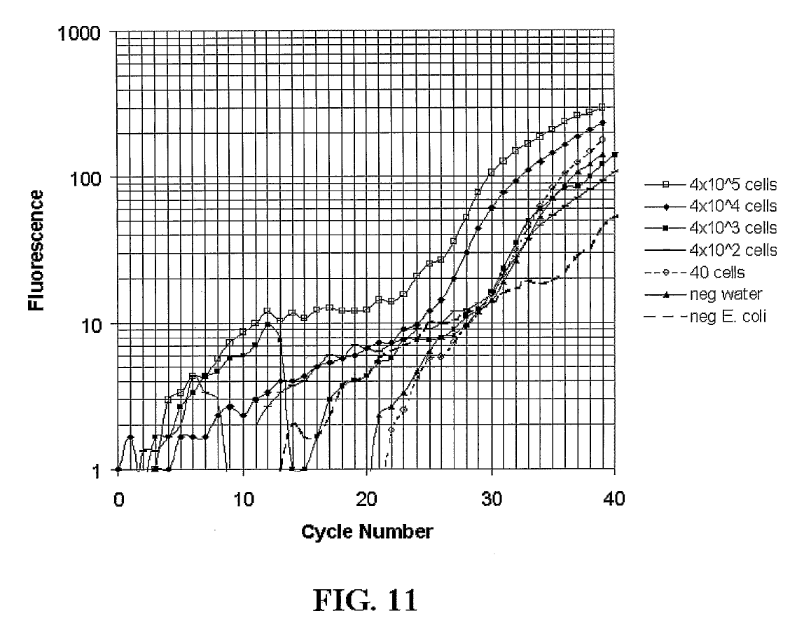

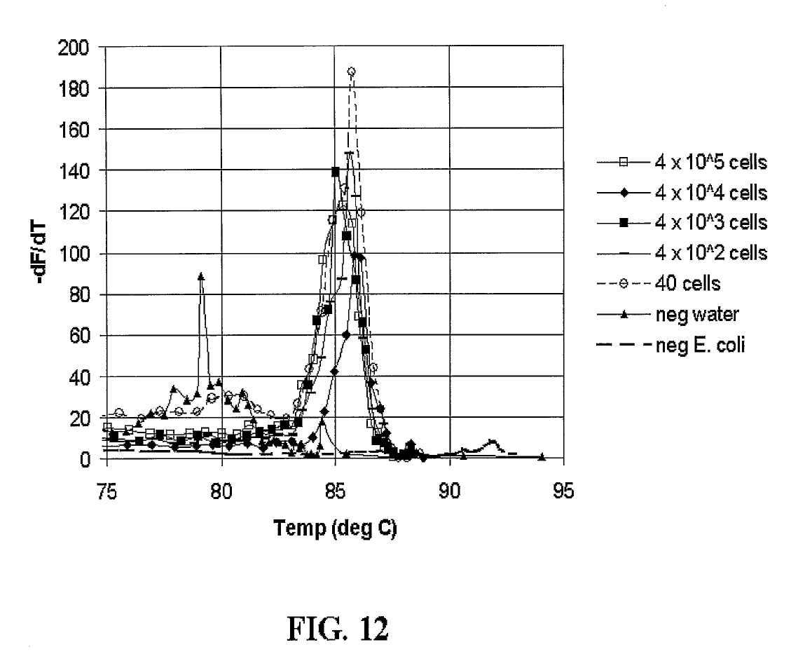

These experiments were also repeated using B. anthracis cells. As for L. monocytogenes, decreasing numbers of cells were used for microchip-based DNA purification and real-time PCR detection. As shown in FIG. 11, for B. anthracis, however, it was possible to detect between 40 and 10⁶ cells. This is a significant increase in sensitivity over the detection of L. monocytogenes. In addition, the detection system was used to perform melting curve analysis of the real-time PCR detection reaction. Because the reaction utilized SYBR Green dye, the temperature of the detection microchip was able to be slowly increase and fluorescence was monitored to observe the melting temperature of the amplified PCR product. This is possible because SYBR Green dye only binds to double stranded DNA and exhibits a 1000-fold decrease in fluorescence intensity when it dissociates from DNA. As the temperature of the reaction mixture is increased, DNA is denatured into single strands, causing dissociation of SYBR Green and a decrease in fluorescence. Therefore, by increasing temperature and monitoring fluorescence, the melting temperature of the PCR product can be determined. This is important because non-specific amplification (such as primer dimmer formation) can cause an increase in fluorescence that is not due to the amplification of the desired PCR product. These non-specific products typically have a lower melting temperature than the specific amplified products. Therefore, a “false positive” result can be differentiated from a “true positive” result by performing melting curve analysis. Melting curve analysis was performed on all of the B. anthracis reactions and are shown in FIG. 12. This figure demonstrates the efficacy of melting curve analysis for differentiating negative and positive results. Note the difference in melting temperature between the negative control (water) and each of the positive (B. anthracis) reactions.

Although the present invention has been disclosed in terms of a preferred embodiment, it will be understood that numerous additional modifications and variations could be made thereto without departing from the scope of the invention as defined by the following claims:

We claim:

1. An integrated detection microchip comprising,
a DNA purification region and
a PCR-based detection region fluidly integrated with said DNA purification region.

2. The integrated detection microchip of claim 1, wherein said DNA purification region includes a microfabricated channel.

3. The integrated detection microchip of claim 2, wherein said DNA purification region includes a plurality of pillars within said microfabrication channel.

4. The integrated detection microchip of claim 3, wherein said plurality of pillars are coated with silica.

5. The integrated detection microchip of claim 1, wherein said PCR-based detection region includes a PCR reaction chamber.

6. The integrated detection microchip of claim 5, wherein said PCR reaction chamber is formed in a poly(dimethyl siloxane) substrate.

7. The integrated detection microchip of claim 1, wherein said DNA purification region is formed in a silicon substrate and said PCR-based detection region is formed in a capping structure.

8. The integrated detection microchip of claim 7, wherein said capping structure includes poly(dimethyl siloxane).

9. The integrated detection microchip of claim 1, further comprising a capping structure covering said DNA purification region and said PCR-based detection region.

10. The integrated detection microchip of claim 9, wherein said capping structure is a poly(dimethyl siloxane) substrate.

11. A portable, fully automated PCR-based detection system, comprising
the integrated detection microchip of claim 1;
a fluorescent detection module for detecting material on said integrated microchip; and
an integrated microprocessor for receiving data from said fluorescent detection module.

12. The portable, fully automated PCR-based detection system of claim 11, wherein said fluorescent detection module includes a light-emitting diode.

13. The portable, fully automated PCR-based detection system of claim 11, wherein said fluorescent detection module includes a photomultiplier tube detector.

14. The portable, fully automated PCR-based detection system of claim 11, wherein said fluorescent detection module includes a first plano-convex lens, a first band pass filter, a mirror, a second band pass filter and a second plano-convex lens.

15. The portable, fully automated PCR-based detection system of claim 11, further comprising an integrated syringe pump.

16. The portable, fully automated PCR-based detection system of claim 11, further comprising a micro valve.

17. The portable, fully automated PCR-based detection system of claim 11, further comprising a thermoelectric heater cooler.

18. The portable, fully automated PCR-based detection system of claim 11, further comprising an integrated syringe pump, a micro valve, a cooling fan, and a thermoelectric heater cooler.

19. A method for making the integrated detection microchip of claim 1 comprising,
forming a plurality of microstructures in a substrate to form a microfabricated channel;
forming a capping structure including a PCR reaction chamber;
bonding said capping structure to said substrate; and
forming a series of holes in said capping structure to provide access holes for fluid introduction and elution.

20. The method of claim 19 wherein said substrate is a silicon substrate.

21. The method of claim 19, wherein said step of forming a plurality of microstructures includes etching.

22. The method of claim 19, wherein said step of forming a capping structure includes photolithographically patterning a negative photoresist.

23. The method of claim 19, wherein said capping structure is a poly(dimethyl)siloxane structure.

24. The method of claim 19, wherein said plurality of microstructures include a plurality of pillars coated with silica.
